(19) United States
(12) Patent Application Publication
(10) Pub. No.: US 2010/0051610 A1
(43) Pub. Date: Mar. 4, 2010

(54) COMBINATION TOOL PRESETTER AND INDUCTION HEAT-SHRINK APPARATUS

(75) Inventors: Victor Wittels, Fairport, NY (US); Matthew Hoyt, Macedon, NY (US)

Correspondence Address: HARRIS BEACH PLLC, 99 GARNSEY ROAD, PITTSFORD, NY, 14534, US

(73) Assignee: Parlec, Inc., Fairport, NY (US)

(21) Appl. No.: 12/199,350

(22) Filed: Aug. 27, 2008

(51) Int. Cl. H05B 6/14; B23P 11/00; B23Q 17/22; B23B 31/117

(52) U.S. Cl. 219/635; 29/447; 29/800; 29/243; 29/407.05; 29/407.1

(57) ABSTRACT

An apparatus is disclosed for accurately positioning a tool within a shrink-fit tool holder. The apparatus includes a combined tool presetter and heat-shrink device. The tool assembly is placed in a precision rotating spindle that is able to travel into a contained location for cooling of the tool assembly subsequent to heating the tool assembly through induction. The apparatus is adapted such that the precision rotating spindle precisely returns to a home measuring position subsequent to cooling for final measurement of the tool assembly. The presetter allows for measurements related to the tool assembly both prior to and subsequent to the shrink-fitting process.

### FIELD OF THE INVENTION

The present invention relates generally to an apparatus for the assembly of tools within tool holders and in particular to an apparatus for accurately positioning a tool within a shrink-fit tool holder. More specifically, the invention is a combination tool presetter and induction heat shrink machine which utilizes a cooling system that allows for higher precision positioning of the tool within the shrink-fit tool holder.

### BACKGROUND OF THE INVENTION

The process of shrink-fitting tools in tool holders is a well known practice in the machining industry. One important aspect of machining processes utilizing heat-shrinking relates to accurately presetting the position of the tool within the shrink-fit tool holder. As such, combination tool presetter and induction heat shrink machines have been developed which allow a user to preset the positioning of a tool during the heat-shrink process and to make final measurements related to the positioning of the tool subsequent to the heat-shrink process.

Another issue related the heat-shrinking process is returning the tool and tool holder to ambient temperature to create the tool assembly. Current combination tool presetter and induction heat-shrink machines return the cutting tool assembly to ambient temperature either by moving the tool assembly to a secondary cooling system or by placing a liquid cooled canister onto the taper of the cutting tool. These methods present several disadvantages.

Initially, air cooled systems and liquid cooled canisters may take upwards of one hour to fully normalize the tool before final measurements can be made. Such a delay as a result of the cooling process negatively affects productivity. Additionally, moving the tool assembly to a secondary cooling system may be dangerous to the operator if he/she is required to handle a hot cutting tool assembly. The accuracy of the final measurements is also affected due to growth/shrinkage of the tool assembly as a result of the temperature changes during the heat-shrink process. Finally, current methods that cool the tool assembly while still in the presetter/heat-shrink machine are limited in accuracy because the heat from the hot cutting tool over time increases the temperature of the spindle that holds the tool assembly causing dimensional changes that will affect the final measurements.

As such, there is a need to provide a combination tool presetter and induction heath-shrink apparatus which includes a system for cooling a cutting tool assembly subsequent to induction heat shrinking that increases productivity, avoids dangerous handling of a hot tool assembly, and provides for accurate final measurement of the completed tool assembly.

### SUMMARY OF THE INVENTION

The present invention provides a combination tool presetter and induction heat-shrink apparatus. The apparatus includes a tool presetter and an induction heat-shrink device. The induction heat-shrink device is designed to integrate in the tool presetter without causing any interference with the measuring area or functions of the tool presetter. The apparatus further comprises a precision rotating spindle which interchangeably accommodates a tool assembly and a cooling chamber. The precision rotating spindle is adapted to travel into the cooling chamber for cooling of the tool assembly. The tool assembly is cooled using jets of liquid coolant. The precision rotating spindle contains rotary seals for preventing fluid contaminants from entering the spindle during cooling of the tool assembly. The tool assembly is dried subsequent to cooling using jets of pressurized air. Further, any heat transferred to the precision rotating spindle by the hot tool assembly is removed during the cooling process.

The precision rotating spindle is adapted to return to a home measuring position subsequent to the cooling of the tool assembly. The precision rotating spindle may be precisely located in the home measuring position. In particular, the precision rotating spindle is precisely located axially in the home measuring position by three hardened rest buttons. The hardened rest buttons are ported axially with pressurized air to remove contaminants while the precision rotating spindle is being located. The precision rotating spindle is precisely located radially in the home measuring position by a linear moving ball cage assembly. The linear moving ball cage assembly has an interference fit to a locating diameter of the spindle which removes any contaminants from the locating surface. The travel of the precision rotating spindle is actuated via a pneumatic cylinder. The pneumatic cylinder is equipped with valving that allows the precision rotating spindle to remain in the home measuring position when the pressurized air source is removed.

The present invention also provides a method for heat-shrink fitting and presetting a tool to a tool holder. The method initially comprises placing the tool holder in a precision rotating spindle which is located in a home measuring position. The tool holder is then heated through induction and the tool is inserted into the tool holder. The location of the tool relative to the tool holder may be preset using the tool presetter. The precision rotating spindle is then lowered into a cooling chamber where the tool and tool holder are cooled using liquid coolant. The precision rotating spindle is then precisely relocated in the home measuring position and the final measurements of the tool relative to the tool holder may be verified.

### BRIEF DESCRIPTION OF THE DRAWINGS

The foregoing and other objects, features, and advantages of the invention will be apparent from the following more particular description of the embodiments of the invention.

FIG. 1 depicts a combination tool presetter and induction heat shrink apparatus in accordance with the present invention.

FIG. 2 depicts a combination tool presetter and induction heat shrink apparatus in accordance with the present invention wherein the apparatus is in a cooling phase.

### DETAILED DESCRIPTION OF THE INVENTION

The present invention is a combination tool presetter and induction heat-shrink apparatus. In particular, the present invention provides a combination tool presetter and induction heat-shrink apparatus which utilizes a cooling system that allows for higher precision positioning of the tool within the shrink-fit tool holder.

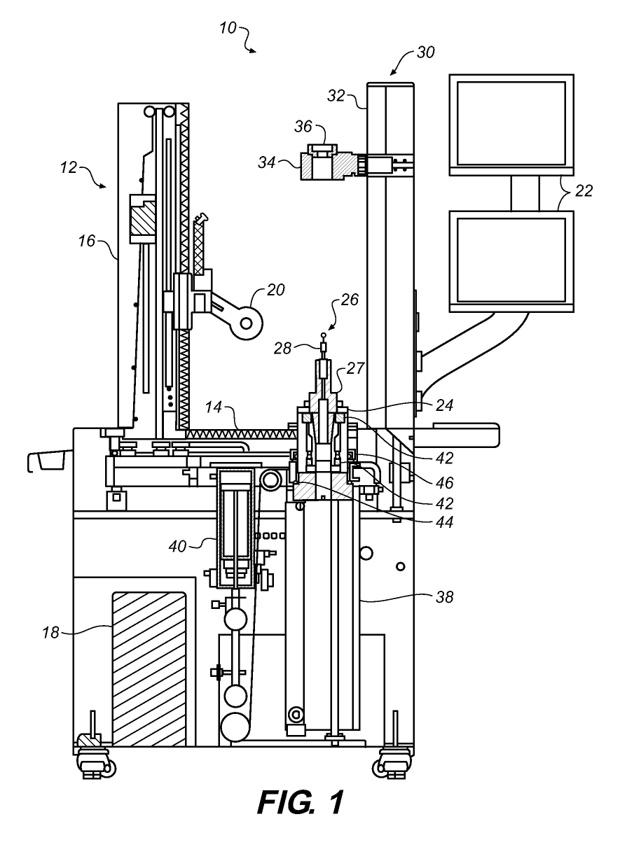

FIG. 1 depicts a combination tool presetter and induction heat shrink apparatus 10 in accordance with the present invention. The tool presetter 12 consists of a rigid base 14 and a vertical presetter column 16. The presetter column 16 is horizontally moveable along the base 14 of the tool presetter 12. The presetter column 16 may be positioned either mechanically by an operator or electronically through the use of servo motors. Further, the positioning of the presetter column 16 may be controlled through a computer system 18. The presetter column 16 supports an optical measuring device 20. The optical measuring device 20 is linearly moveable along the presetter column 16. The optical measuring device 20 may be positioned either mechanically by an operator or electronically through the use of servo motors. The positioning of the optical measuring device may be controlled through the computer system 18. The optical measuring device 20 is electronically connected to a display interface 22 that allows a user to accurately position both the presetter column 16 and the optical measuring device 20 during the presetting process.

The tool presetter 12 further comprises a precision rotating spindle 24 that can interchangeably accommodate a tool assembly 26 consisting of a shrink-fit tool holder 27 and a tool 28. The tool assembly 26 is located in the precision rotating spindle 24 via a taper. The precision rotating spindle 24 is shown in the home measuring position in FIG. 1. The presetter column 16 and the optical measuring device 20 may be positioned such that the optical measuring device 20 is utilized to measure the length and diameter of the tool assembly 26. The tool assembly 26 may be optically located by a user on the display interface 22.

The apparatus 10 also includes an induction heat-shrink device 30. The induction heat-shrink device 30 consists of a heat-shrink column 32. The induction heat-shrink column 32 is designed to integrate in the tool presetter 12 without causing any interference with the existing measuring area or functions of the tool presetter 12. The induction heat-shrink device 30 further comprises an induction head 34 which includes a heating coil and is utilized to heat and provide thermal expansion of the tool holder 26. The induction head 34 is mounted on the heat-shrink column 32 and includes a cylindrical aperture 36 through which a portion of the tool holder 27 may extend. The induction head 34 is vertically moveable along the heat-shrink column 32. The induction head 34 may be positioned either manually or pneumatically through the use of an air cylinder. The position of the induction head 34 may be controlled through the computer system 18.

The apparatus 10 further includes a cooling system that is utilized to rapidly return the tool assembly 26 to ambient temperature subsequent to the heat-shrink process. The cooling system consists of a cooling chamber 38 which is a contained location below the precision rotating spindle 24. The cooling process may be initiated by a user through the computer system 18.

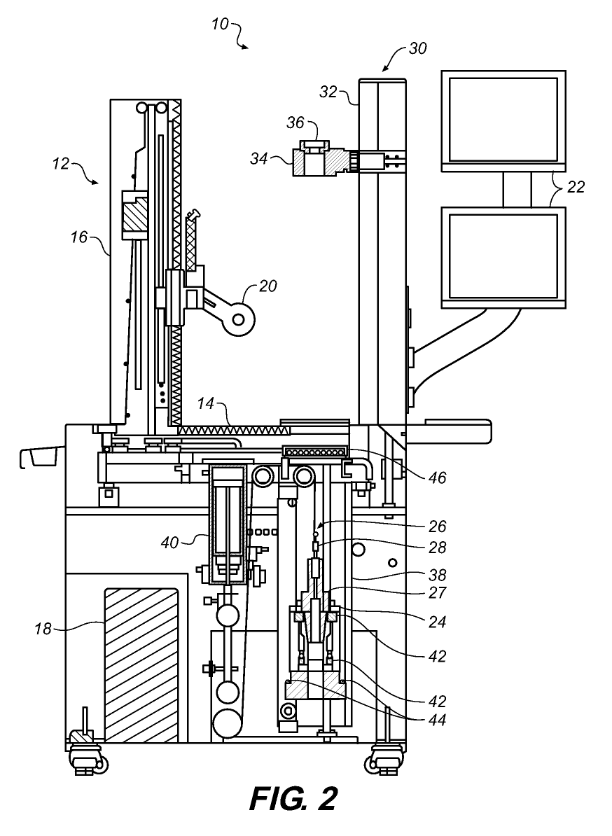

While the hot cutting tool assembly 26 is still in the precision rotating spindle 24, the precision rotating spindle 24 is lowered into the cooling chamber 38. FIG. 2 depicts the apparatus 10 with the precision rotating spindle 24 in the cooling location. The motion of the precision rotating spindle 24 is actuated via a pneumatic cylinder 40. The pneumatic cylinder 40 is equipped with valving that allows the precision rotating spindle 24 to remain in the home measuring position when the pressurized air source is removed from the machine.

The tool assembly 26 is cooled utilizing streams of a cooling fluid that flow directly onto the tool assembly 26 and the precision rotating spindle 24. The cooling process takes approximately 20-30 seconds. The precision rotating spindle 24 contains rotary seals 42 to prevent fluid contaminants from entering the precision spindle bearings. Any heat transferred from the hot tool assembly 26 into the precision rotating spindle 24 is removed during the cooling process. Any fluid remaining on the tool assembly 26 and the precision rotating spindle 24 is removed via jets of pressurized air.

After the cooling process is complete the precision rotating spindle 24 travels back to the home position. The precision rotating spindle 24 is precisely located both axially and radially in the home measuring position. The precise relocation of the precision rotating spindle 24 allows for an accurate final measurement of the tool assembly 26 utilizing the tool presetter 12. The precision rotating spindle 24 is located axially via hardened rest buttons 44. The upper rest buttons 44 are ported axially with pressurized air to remove contaminants to ensure the repeatability of the system. The precision rotating spindle 24 is precisely located radially with a linear moving ball bearing cage assembly 46. The ball bearing cage assembly 46 is designed with an interference fit to a locating diameter of the precision rotating spindle 24. The interference fit removes any contaminants from the locating surface of the precision rotating spindle 24 for a less than 2 micron precision repeatability of the system.

After the precision rotating spindle 24 is precisely located in the home measuring position, the tool assembly 26 can then be measured using the tool presetter 12. The entire operation from heating to cooling and measuring can be performed in under two minutes, which increases productivity. Further, the cooling process is completed without endangering the operator with handling a hot tool assembly 26 that could reach temperatures of over 700 degrees Fahrenheit. The other benefit of the process is that the tool assembly 26 is 100% normalized during the cooling cycle and can be measured instantly when the cycle is complete.

While illustrative embodiments have been presented and described, it will be clear to those proficient in the art that various changes can be made therein without departing from the spirit and scope of the invention.

What is claimed is:

1. A combination tool presetter and induction heat-shrink apparatus comprising:
a tool presetter;
an induction heat-shrink device;
a precision rotating spindle which interchangeably accommodates a tool assembly; and
a cooling chamber;
wherein the precision rotating spindle is adapted to travel into the cooling chamber for cooling of the tool assembly.

2. The apparatus of claim 1 wherein the precision rotating spindle is adapted to return to a home measuring position subsequent to the cooling of the tool assembly.

3. The apparatus of claim 2 wherein the precision rotating spindle is precisely located in the home measuring position subsequent to cooling of the tool assembly.

4. The apparatus of claim 1 wherein the precision rotating spindle contains rotary seals for preventing fluid contaminants from entering the spindle during cooling of the tool assembly.

5. The apparatus of claim 1 or claim 3 wherein the travel of the precision rotating spindle is actuated via a pneumatic cylinder.

6. The apparatus of claim 5 wherein the pneumatic cylinder allows the precision rotating spindle to remain in the home measuring position when the pressurized air source is removed.

7. The apparatus of claim 4 wherein the precision rotating spindle is precisely located axially in the home measuring position by hardened rest buttons.

8. The apparatus of claim 7 wherein the hardened rest buttons are ported axially with pressurized air to remove contaminants while the precision rotating spindle is being located.

9. The apparatus of claim 4 wherein the precision rotating spindle is precisely located radially in the home measuring position by a linear moving ball cage assembly.

10. The apparatus of claim 9 wherein the linear moving ball cage assembly has an interference fit to a locating diameter of the spindle which removes any contaminants from the locating surface.

11. The apparatus of claim 1 wherein heat transferred to the precision rotating spindle by the hot tool assembly is removed during the cooling process.

12. A method for heat-shrink fitting and presetting a tool to a tool holder comprising:
placing the tool holder in a precision rotating spindle which is located in a home measuring position;
heating the tool holder through induction;
inserting a tool into the tool holder;
presetting the location of the tool relative to the tool holder;
lowering the precision rotating spindle into a cooling chamber;
cooling the tool and tool holder using liquid coolant; and
precisely relocating the precision rotating spindle in the home measuring position.

13. The method of claim 12 further comprising:
verifying the final measurements of the tool relative to the tool holder.
